(19) United States
(12) Patent Application Publication
(10) Pub. No.: US 2009/0116108 A1
(43) Pub. Date: May 7, 2009

(54) Lenticular Autostereoscopic Display Device and Method, and Associated Autostereoscopic Image Synthesizing Method

(76) Inventors: Xavier Levecq, Gif Sur Yvette (FR); Armand Azoulay, Paris (FR)

Correspondence Address: James H Patterson;Patterson Thuente Skaar&Chritensen, 4800 Ids Center, 80 South 8th Street, Minneapolis, MN, 55402, US

(21) Appl. No.: 11/665,700

(22) PCT Filed: Oct. 14, 2005
(86) PCT No.: PCT/FR2005/002561

§ 371 Date: Dec. 13, 2007

(30) Foreign Application Priority Data
Oct. 18, 2004 (FR) 0411019

(51) Int. Cl. G02B 27/22

(52) U.S. Cl. 359/463

(57) ABSTRACT

An autostereoscopic display device comprises a matrix display screen having a horizontal axis and a vertical axis, and a lenticular array arranged in front of the display screen and having a lenticular axis that is inclined in relation to the vertical axis. The display device emits an image comprising a set of three-dimensional pixels, each three-dimensional pixel including a plurality of viewpoints of a corresponding image pixel of a scene to be displayed. For each three-dimensional pixel, the plurality of viewpoints of each corresponding image pixel are encoded along a horizontal axis, while color components associated with each viewpoint of each image pixel are encoded in separate rows generally aligned along an encoding axis that is substantially parallel to the lenticular axis.

### RELATED APPLICATIONS

This application claims priority to PCT Application No. PCT/FR2005/0002561 filed Oct. 14, 2005, and French Application No. 0411019 filed Oct. 18, 2004, the disclosures of which are hereby incorporated by reference in their entireties.

### TECHNICAL FIELD

This invention relates generally to a lenticular autostereoscopic display device. It also concerns an autostereoscopic display method implemented in this device, as well as an associated autostereoscopic image synthesizing method. The field of the invention is more particularly that of three-dimensional color display screens intended, for example, for broadcasting advertising or public information messages.

### BACKGROUND ART

Glasses-free autostereoscopic display devices are already known, which implement either parallax barrier technologies or lenticular technologies. Overall, an autostereoscopic display screen includes:
a plasma or liquid crystal (LCD) technology, two-dimensional electronic screen broadcasting a previously encoded content, and
a 2D-3D conversion screen, arranged at a short distance from the two-dimensional screen and operating during transmission, this screen being capable of being either the parallax barrier type or the lenticular type.

Parallax barriers are easy to implement, and inexpensive to produce, but constitute an impediment, having too many photons, especially when it is desired to encode numerous angles of view. Thus, it is possible for less than 10% of an autostereoscopic screen mask to be transmitted. This results in problems relating to the photon flux and brightness of the screen.

Autostereoscopic screens that implement lenticular arrays have very few photon losses and therefore have a transmission rate close to 100%, but are more costly to manufacture and more difficult to use.

However, current lenticular color autostereoscopic screens have a horizontal resolution loss problem based on the number of viewpoints. The resolution is divided by the number of angles of view. Such being the case, in order to ensure the comfort of the viewers in front of an autostereoscopic screen, it is necessary to provide a large number P of viewpoints. The blurred areas of the screen represent a surface factor 1/P. It appears that a good compromise in the choice of P lies between 8 and 10.

Thus, the problem posed is to find an appropriate way to encode the P views on the 2D electronic screen in order to equalize the horizontal and vertical resolution losses, while at the same time preserving the RGB (Red Green Blue) color encoding. The stereoscopic effect must necessarily be a horizontal effect, due to the morphology of the eyes. Thus, stereoscopic encoding must necessarily be horizontal.

Thus, the document WO 0010332 discloses encoding horizontally in a row. The encoding of the color is also carried out horizontally in a row, with a different color per successive 3D pixel (lenticule). This means that the lenticules are vertical, but the loss of resolution is only on the horizontal axis. The consequence of this is that the image for each take is very dissymmetrical. For example, if a 2D, 1200×768 pixel size screen is considered, and if 8 images are encoded, the resolution for each view is therefore 150×768, which represents a significant loss of resolution over the entire image.

Furthermore, the colors encoding a 3D pixel are very distant from each other, with twice the pitch of the lenticule for encoding the three colors. A mixing together of the colors is then obtained, which is not very good on the retina, if many angles of view are desired.

In the autostereoscopic screen disclosed in the document EP 0791847B1, the views are encoded horizontally overall, but also vertically in a minimum of 3 rows of screen pixels. The color-encoding surface is at least equal to one time the size of the lenticule (in the horizontal direction) per 3 screen pixels (in the vertical direction). The loss of resolution is horizontally and vertically uniform. However, if encoding such as this appears to be appropriate for 2D screens in which the spacing between the pixels and between the color cells of the pixels is significant, as in the case of some LCD screens, then, by contrast, it cannot be satisfactorily suitable for plasma screens in which the cells are very close together, or even nearly joined together, which would lead to a significant mixing together of the images of the various views.

### SUMMARY OF THE INVENTION

One aspect of the invention is to propose a lenticular color autostereoscopic display device obtaining better resolution than the current devices.

This objective is attained with an autostereoscopic display device including a matrix display screen and a lenticular array arranged in front of the display screen and having a lenticular axis that is inclined in relation to a vertical axis of the display screen, this lenticular array being designed to receive and optically process a raster image transmitted by the display screen, this raster image being encoded in order to integrate a plurality P of viewpoints of the same scene.

According to one aspect of the invention, the image transmitted by the display screen comprises a set of three-dimensional pixels, each including the plurality of P viewpoints of an image pixel of the scene being displayed and, in each three-dimensional pixel, the various viewpoints of an image pixel in question are encoded horizontally, while the three colors associated with each viewpoint of said image pixel in question are encoded in three rows along an encoding axis that is substantially parallel to the lenticular axis.

In this case, an image is understood to mean a scene that is represented in relief. To accomplish this, a plurality P of viewpoints of this image is necessary. One image pixel corresponds to the P viewpoints of one pixel of the scene.

The problem of equalizing the loss of horizontal and vertical resolution is resolved with a display device according to aspects of the invention, in particular for a number of viewpoints of around 8, 9 or 10. As a matter of fact, contrary to the encoding techniques used in the devices of the prior art, in aspects of this invention, an actual separation is made between, on the one hand, the problem of stereoscopy, which must necessarily be dealt with in the horizontal dimension, and that of color encoding, which is dealt with here in three rows along an encoding axis that is actually that of the lenticular array.

In a more specific embodiment of an autostereoscopic display device according to one aspect of the invention, in which:
the matrix display screen includes a set of pixels each comprising three color columns (RGB), this screen being designed to receive signals resulting from encoding a content of N three-dimensional pixels according to a plurality P of viewpoints, and
the lenticular array includes a plurality of cylindrical lenses arranged in parallel along a lenticular axis forming a predetermined tilt angle α with respect to the axis of the columns of the display screen,

each three-dimensional pixel is encoded, for each viewpoint among the plurality P of viewpoints, in the form of a first cell of a first color, a second cell of a second color and a third cell of a third color, said first, second and third cells being arranged, respectively, in three consecutive rows and in three consecutive color columns, along a diagonal substantially parallel to the axis of the lenses, the P successive viewpoints associated with the same image pixel being arranged consecutively along the horizontal axis, with cyclical offsetting of said first, second and third colors.

The lenticular array is advantageously laid out whereby, in one row of the matrix screen, each lens of the lenticular array substantially covers a number of cells equal to the number P of viewpoints.

The pitch of the lenticular array is preferably chosen to be substantially equal to the product of the horizontal width of the plurality P of viewpoints of the same image pixel and the cosine of the tilt angle α.

The tilt angle α is therefore advantageously chosen such that tan α is substantially equal to the ratio of the width of a color cell to the height of said color cell.

In a preferred embodiment of an autostereoscopic display device according to one aspect of the invention, the electronic display screen is a plasma screen.

According to another aspect of the invention, an autostereoscopic display method is proposed, which is used for an autostereoscopic display device according to one type of embodiment of the invention, this method including:
displaying an image previously encoded from an image acquired from a plurality of viewpoints, via a two-dimensional display screen, and
receiving and optically processing said displayed image, via a lenticular array arranged in front of said display screen and having a lenticular axis that is inclined in relation to a vertical axis of said display screen, so as to remotely generate a three-dimensional image, said raster image being encoded in order to integrate a plurality of viewpoints of said image.

According to one aspect of the invention, the image transmitted by the display screen comprises a set of three-dimensional pixels each including the plurality P of viewpoints of an image pixel of the scene being displayed and, in each three-dimensional pixel, the various viewpoints of an image pixel in question are encoded horizontally, while the three colors associated with each viewpoint of said image pixel in question are encoded in three rows along an encoding axis that is substantially parallel to the lenticular axis.

In one specific implementation embodiment of the display method according to aspects of the invention, in which this method includes:
a matrix display, by means of an electronic display device, of a set of pixels each including three color cells (RGB) arranged horizontally, from an encoding of signals resulting from encoding a content of N three-dimensional pixels according to a plurality P of viewpoints, and
production of stereoscopic images via a lenticular array arranged in front of the display screen, this array including a plurality of cylindrical lenses arranged in parallel along a lenticular axis forming a predetermined tilt angle α with respect to the axis of the columns of the display screen,

each viewpoint, of a given three-dimensional pixel, being encoded on a first cell of a first color, a second cell of a second color and a third cell of a third color, said first, second and third cells being arranged respectively in three consecutive rows and in three consecutive color columns, along a straight line substantially parallel to the axis of the lenses, the P successive viewpoints associated with the same image pixel being arranged consecutively along the horizontal axis, with cyclical offsetting of said first, second and third colors.

According to yet another aspect of the invention, a method is proposed for synthesizing a color autostereoscopic image, implemented in order to supply a display device according to one embodiment with image content, this method including:

from a plurality P of available digital images each in the form of a matrix of image pixels in Hi rows and Vi columns of color pixels and each corresponding to one of the P viewpoints of the image, each color pixel comprising three horizontally consecutive color cells,

synthesis of an encoded display matrix comprising an assemblage of three-dimensional pixels each associated with one of said image pixels, each three-dimensional pixel including a set of P encoded pixels each corresponding to a viewpoint associated with said image pixel, each encoded pixel comprising three first, second and third encoding cells associated, respectively, with a first, a second and a third color and arranged, respectively, in three consecutive rows and consecutive columns so that said encoded pixel associated with a given viewpoint is substantially aligned along a diagonal between cells offset over several consecutive rows and columns, said encoded pixels of the same three-dimensional pixel being arranged consecutively along the horizontal axis, with cyclical offsetting of the colors within each consecutive encoded pixel.

### BRIEF DESCRIPTION OF THE DRAWINGS

Other advantages and characteristics of the invention will become more apparent upon examination of the detailed description of a non-limiting embodiment, and from the appended drawings in which:

FIG. 1 is a synoptic view of an autostereoscopic display device according to one aspect of the invention,

FIG. 2 shows the internal structure of an encoded image processed by the autostereoscopic display device according to one aspect of the invention, and

FIG. 3 shows the principal steps of the image synthesizing method according to one aspect of the invention.

### DETAILED DESCRIPTION OF THE DRAWINGS

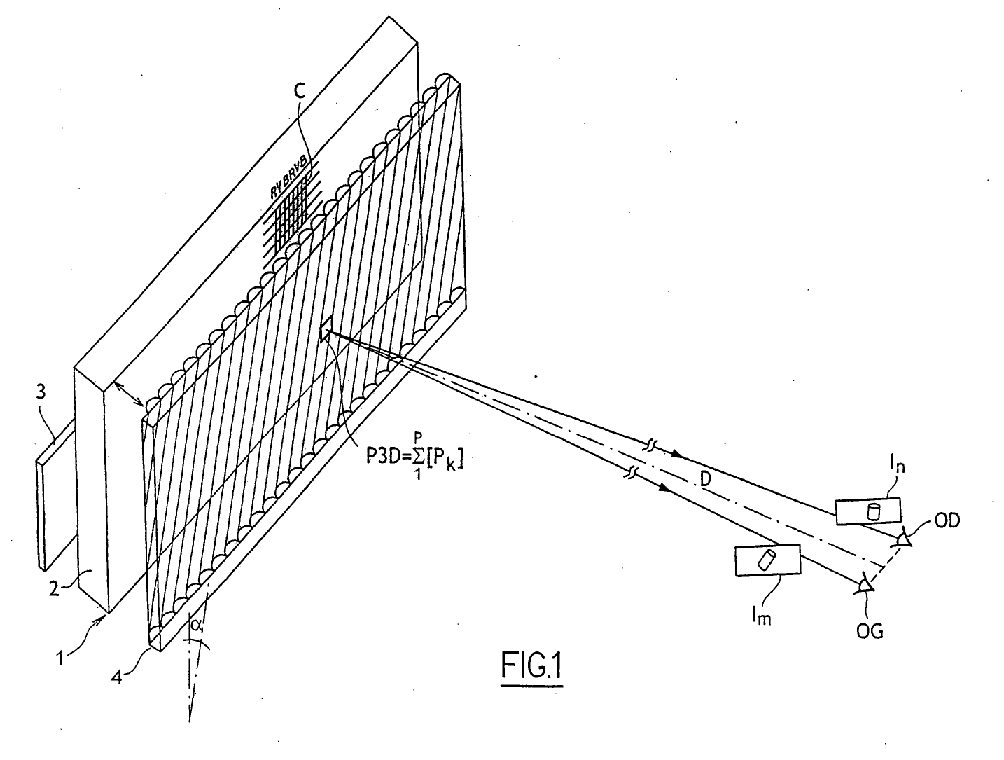

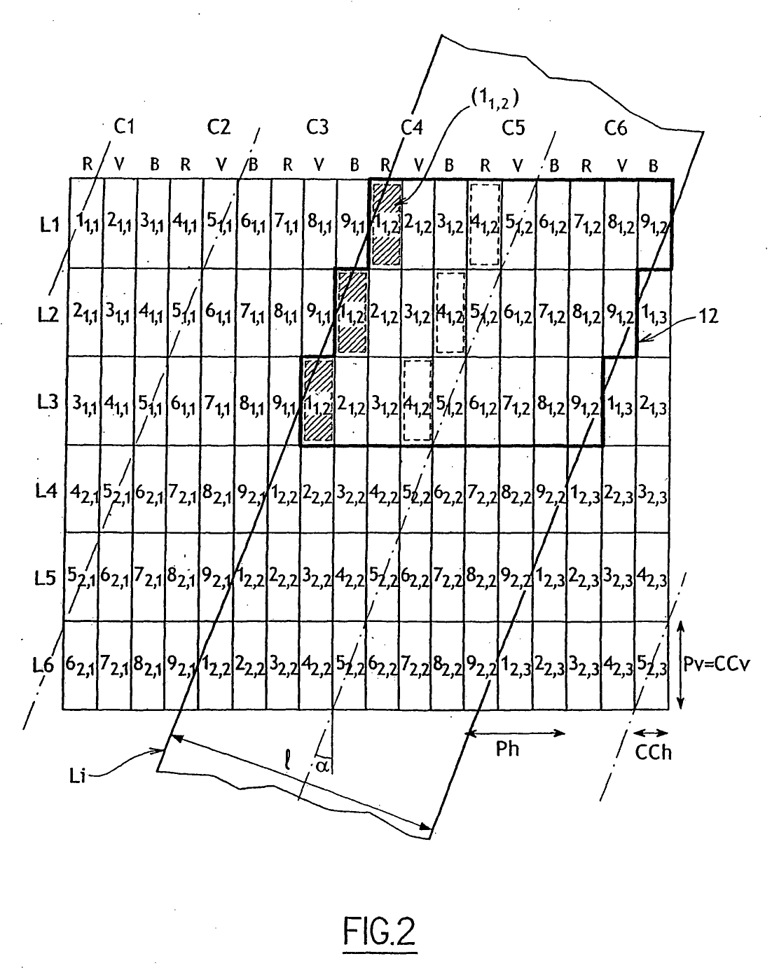

An exemplary autostereoscopic display device according to one aspect of the invention will first be described with reference to FIGS. 1 and 2.

The autostereoscopic display device 1 includes a plasma screen 2 connected to an electronic module 3 for generating encoded images, and a lenticular filter 4 in the form of an array of parallel cylindrical lenses inclined at an angle α in relation to the vertical axis of the plasma screen, this lenticular filter 4 being arranged in front of the plasma screen at a distance substantially equal to the focal length F1 of the lenses, which in an actual exemplary embodiment is 20 mm, while each color cell of the display screen has a width of 286 μm.

The autostereoscopic display device according to this embodiment of the invention is considered to provide a display of advertising or informational messages at a sufficiently large distance D from the screen, e.g., at a distance greater than 4.5 m, whereby each eye OG OD of a viewer receives separate optical images Im, In, provided by the lenticular array 4 and whereby, via a stereoscopic effect, this viewer perceives a three-dimensional image.

The focal distance of the cylindrical lenses depends on the desired optimal distance. At this optimal distance, it is necessary for two successive images, encoded by two successive color cells, to be separated by the average distance Dy between two eyes, e.g., by 65 mm. The focal distance f of the lenses can be determined on the basis of the width CCh of a color cell and the optimal distance Dopt, using the formula:

F=CCh.Dopt/Dy≈20 mm

If, for example, the desired optimal distance Dopt is 4.5 m, and the width CCh is equal to 286 μm, then the focal distance f is approximately 20 mm.

With reference to FIG. 2, the plasma screen 2 comprising a matrix of elementary cells comprising V rows of pixels, L1-L6 in FIG. 2, and H pixel columns, C1-C6 in FIG. 2, each column of pixels including three columns of color cells R V B. For non-limiting illustrative purposes, each cell has a height CCv and a width CCh. The columns of the display matrix are successive Red, Green and Blue color cell columns. In the case described, the number P of viewpoints taken into account in the stereoscopic encoding of the image is equal to 9.

To illustrate, for a plasma technology screen commercially available at present, such as the PIONEER PDP50MXE1, corresponding to a 768×1280 pixel matrix, each cell has a height CCv equal to 808 μm and a width CCh of 286 μm.

The display matrix MC is encoded so as to include a set of three-dimensional pixels or 3D pixels, each 3D pixel comprising 9 encoding pixels each corresponding to a viewpoint of an encoded image pixel and arranged horizontally within the 3D pixel. Thus, with reference to FIG. 1, each 3D pixel can be considered as an assemblage of P (e.g., 9) encoding pixels Pk of the same encoded image point in the display matrix with P viewpoints.

By way of the example shown in FIG. 2, a 3D pixel 12, which corresponds to an image point coordinate (1,2), consists of 9 encoding pixels (1_{1,2}), (2_{1,2}), (3_{1,2}), (4_{1,2}), (5_{1,2}), (6_{1,2}), (7_{1,2}), (8_{1,2}), (9_{1,2}), each associated with a viewpoint for the image pixel (1,2) concerned. The encoding pixel (1_{1,2}) itself consists of the three following cells:
a first “Red” cell 1_{1,2} situated in the pixel column C4 and in the row L1,
a second “Blue” cell 1_{1,2}, situated in the pixel column C3 and in the row L2, and
a third “Green” cell 1_{1,2} situated in the pixel column C3 and in the row L3.

The 9 encoding pixels of the 3D pixel 12 are horizontally overlapping and substantially covered by the cylindrical lenticule Li, which has a tilt angle α and a width l that are determined in order to ensure this coverage of the 3D pixels.

The tilt angle α is such that tan α is equal to the ratio of the height CCv of a cell to its width CCh.

The width l of the lenticule depends in particular on the desired optimal distance. As a matter of fact, when the viewer is at the optimal distance (final distance), the distance separating two points of the two-dimensional screen viewed simultaneously by one eye of the viewer, through two successive cylindrical lenses, is not exactly equal to the horizontal distance separating the axes of the cylindrical lenses. The relationship of proportionality is equal to Dopt/(Dopt+f).

The width l of each lenticular element can thus be determined from the following formula:

l=cos α.P.CCh.Dopt/(Dopt+f)

Each encoding pixel thus includes three color cells each belonging to a consecutive row of pixels and to a color column within the 3D pixel, whereby this encoding pixel has a color-encoding axis that is substantially parallel to the lenticular array axis. Furthermore, the color sequence of each encoding pixel is cyclically offset in relation to each consecutive encoding pixel within a 3D pixel.

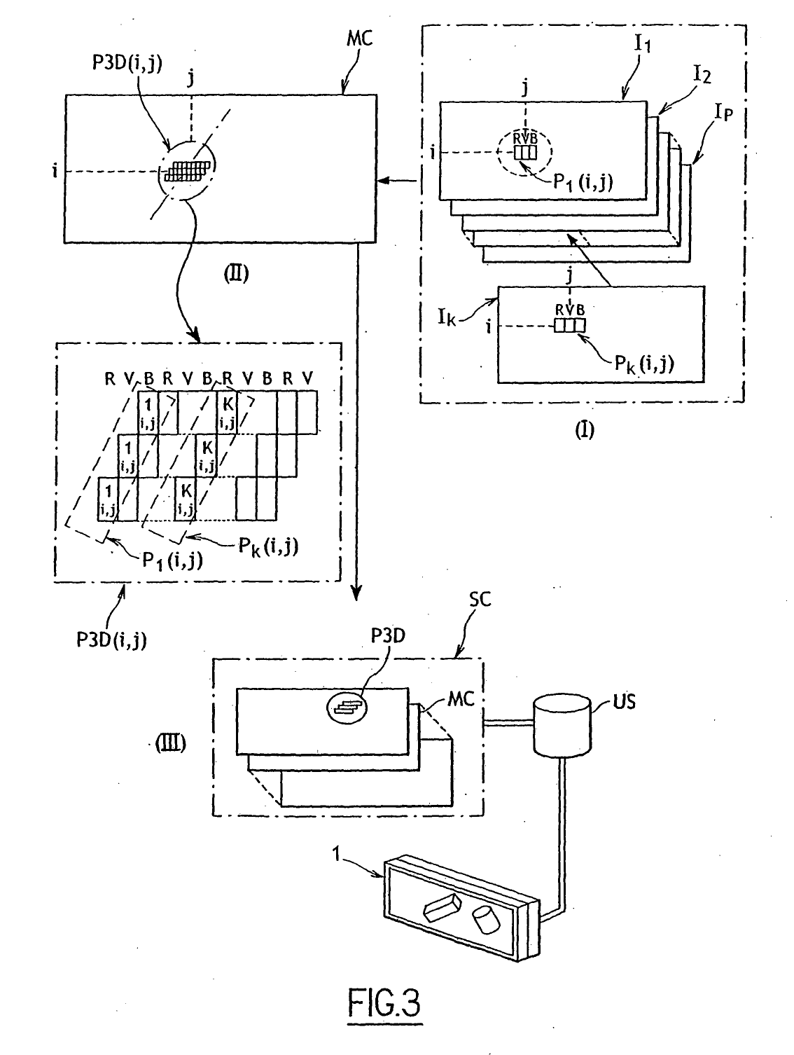

An example of implementing an autostereoscopic image synthesizing method according to one embodiment of the invention will now be described with reference to FIG. 3, these images being intended to supply an autostereoscopic display device according to aspects of the invention.

Considered first of all is a preliminary phase (I) for obtaining digital images according to a plurality P of viewpoints, e.g., numbering 9, that are appropriately chosen in order to obtain a stereoscopic effect.

The P digital images can be either synthesized or collected from remote sites or image banks, or else acquired by film shooting.

For each viewpoint, each of these digital images I₁, I₂, . . . , I_{K}, . . . I_{P} includes a matrix of image pixels, each of these image pixels P₁(i, j), . . . , P_{K}(i, j) containing three pieces of color information R V B.

A second phase (II) of the synthesizing method comprises constructing a display matrix MC by creating, for each image point (i, j), a 3D image, referenced as P3D(i, j) in FIG. 3, from the aggregation of the 9 image pixels corresponding to the 9 viewpoints, using the encoding mode specific to the embodiment of the invention, i.e., horizontal encoding of the stereoscopic viewpoints and inclined encoding of the colors of each encoding pixel P₁(I, j), . . . P_{K}(i, j).

In a third phase (III), the display matrices MC each corresponding to an image of an encoded sequence SC, are then stored in a image storage unit US intended to be activated in response to a request coming from a control processor of an autostereoscopic display device 1 according to one embodiment of the invention.

Of course, the invention is not limited to the examples just described and numerous features can be added to these examples without exceeding the scope of the invention. In particular, the invention is not limited to the single case of a plasma screen, but can be implemented with other screen types having a matrix structure, with contiguous or spaced-apart cells. Furthermore, it is of course possible to accommodate a number of viewpoints other than 9, provided that it is at least equal to two, and color encoding other than RGB, which currently constitutes the benchmark in the field of color display.

1-22. (canceled)

23. An autostereoscopic display device comprising:
a matrix display screen having a horizontal axis and a vertical axis;
a lenticular array arranged in front of said display screen and having a lenticular axis that is inclined in relation to the vertical axis;
said lenticular array being designed to receive and optically process a raster image emitted by said display screen;
wherein said raster image comprises a plurality of image pixels composed of a plurality of color components, and is encoded to combine a plurality P of viewpoints of a scene;
wherein said image emitted by said display screen comprises a set of three-dimensional pixels, each three-dimensional pixel including said plurality P of viewpoints of a corresponding image pixel of said scene;
wherein for each three-dimensional pixel, said plurality P of viewpoints of each corresponding image pixel are encoded along said horizontal axis, while said color components associated with each viewpoint of each of said image pixel are encoded in separate rows generally aligned along an encoding axis that is substantially parallel to said lenticular axis.

24. The device of claim 23, wherein:
said matrix display screen includes a set of display pixels, each display pixel comprising color columns situated in alignment with the vertical axis, the matrix display screen being adapted to receive signals encoded with content representing a plurality N of said three-dimensional pixels; and
said lenticular array includes a plurality of cylindrical lenses arranged in parallel with one another along said lenticular axis such that a predetermined tilt angle with respect to said vertical axis is formed;
each of said plurality N of three-dimensional pixels is configured to represent said plurality P of viewpoints by including at least a first cell of a first color, a second cell of a second color and a third cell of a third color, said first, second and third cells being arranged, respectively, in consecutive rows aligned with said horizontal axis and in consecutive color columns, along a diagonal axis substantially parallel to said lenticular axis, wherein said plurality P of viewpoints that are associated with any image pixel are arranged consecutively along said horizontal axis with cyclical offsetting of said first, second and third colors.

25. The device of claim 24, wherein the lenticular array is laid out such that in a first row of the matrix display screen, each cylindrical lens of the lenticular array substantially covers a quantity of color cells that is equal to the number P of viewpoints.

26. The device of claim 25, wherein a pitch of the lenticular array is substantially equal to a product of a horizontal width of the plurality P of viewpoints of an image pixel, a cosine of said tilt angle, a ratio of an optimal display distance to a sum of said optimal distance and a focal distance of the lenticular array.

27. The device of claim 26, wherein said tilt angle is chosen such that its tangent is substantially equal to a ratio of a width of a color cell to a height of said color cell.

28. The device as claimed in claim 23, wherein said electronic display screen is a plasma screen.

29. The device as claimed in claim 23, wherein said electronic display screen is a liquid crystal screen.

30. An autostereoscopic display method, comprising:
displaying, via a two-dimensional display screen, an image that is encoded with a plurality P of viewpoints, including providing a set of three-dimensional pixels, each representing said plurality P of viewpoints;
receiving and optically processing said image via a lenticular array arranged in front of said display screen, said lenticular array having a lenticular axis that is inclined in relation to a vertical axis of said display screen so as to remotely generate a three-dimensional image; and
for each three-dimensional pixel, encoding said plurality P of viewpoints of a corresponding portion of said image in a sequence along a horizontal axis of said two-dimensional display screen, and encoding a plurality of colors corresponding to each viewpoint for said corresponding portion of said image in a sequence along separate rows that are substantially parallel to the lenticular axis.

31. The method of claim 30, further comprising:
providing a matrix display via an electronic display device, the matrix display comprising of a set of pixels, each pixel including three color cells arranged along said horizontal axis, wherein said set of pixels is based on an encoding of signals resulting from encoding content of N three-dimensional pixels according to said plurality P of viewpoints, and
producing stereoscopic images via said lenticular array arranged in front of said display screen, said lenticular array providing a plurality of cylindrical lenses arranged in parallel win one another along said lenticular axis;
encoding each viewpoint of any of said three-dimensional pixel onto a first cell of a first color, a second cell of a second color and a third cell of a third color that are arranged respectively in three consecutive rows aligned with said horizontal axis, and arranged in three consecutive color columns aligned substantially with said lenticular axis, said plurality P of viewpoints associated with an image pixel being arranged consecutively along said horizontal axis, with cyclical offsetting of said first, second and third colors.

32. A method for synthesizing a color stereoscopic image with image content from a plurality of previously obtained or collected digital images, each in the form of a matrix of image pixels, the method comprising:
providing a display device having a plurality of display pixels, each display pixel comprising three consecutive color cells situated along a first axis;
synthesizing an encoded display matrix comprising an assemblage of three-dimensional pixels, including:
providing, for each three-dimensional pixel, a set of encoded elements that each correspond to a viewpoint associated with a corresponding one of said image pixels,
providing, for each encoded element, a group of first, second, and third encoding cells associated respectively with a first, a second and a third color;
arranging said encoding cells respectively in consecutive rows and consecutive columns such that encoding cells of a first encoded element associated with a first viewpoint are substantially aligned diagonally with respect to said rows and columns; and
arranging said encoded elements of a given three-dimensional pixel consecutively along said first axis, with cyclical offsetting of colors within each consecutive encoded element.

33. The method of claim 32, wherein each column of said synthesized display matrix contains encoding cells associated with the same color.
